(19) United States
(12) Patent Application Publication
(10) Pub. No.: US 2023/0281394 A1
(43) Pub. Date: Sep. 7, 2023

(54) INFORMATION PROCESSING DEVICE AND INFORMATION PROCESSING METHOD

(71) Applicant: SONY GROUP CORPORATION, TOKYO (JP)

(72) Inventor: KAN KURODA, TOKYO (JP)

(21) Appl. No.: 18/004,412

(22) PCT Filed: Jul. 5, 2021
(86) PCT No.: PCT/JP2021/025252

§ 371 Date: Jan. 5, 2023

(30) Foreign Application Priority Data
Jul. 15, 2020 (JP) 2020-121389

(51) Int. Cl. G06F 40/30; G06N 20/10

(52) U.S. Cl. CPC G06F 40/30; G06N 20/10

(57) ABSTRACT

An information processing device (10) includes a control unit (110). The control unit (110) performs machine learning using positive example data and negative example data, and generates a model. The control unit (110) calculates a correspondence rate that a plurality of pieces of example sentence data corresponds to an intention by using the model. The control unit (110) selects presented data to be presented to a user from a plurality of pieces of example sentence data based on a predetermined threshold and a correspondence rate of the plurality of pieces of example sentence data. The control unit (110) receives a determination of whether or not the presented data corresponds to the intention from the user. The control unit updates a predetermined threshold in accordance with a determination result.

### FIELD

The present disclosure relates to an information processing device and an information processing method.

### BACKGROUND

There is known an interaction system that calls a specific function in accordance with text input by a user. In such an interaction system, whether or not the specific function is called in accordance with the input text is determined by using a learned identifier (model) generated by using an existing positive example/negative example and a rule.

In order to reduce costs for creating the model, there is known a technique of updating an utterance database by using a rephrasing result based on a rule from a sentence input by a user. In such a technique, an intention is estimated by using a model for estimating the intention from databases of utterances and intentions and the rephrasing result based on the rule from a sentence input by a user. Moreover, in such a technique, the utterance database is updated after confirming the intention with the user in accordance with the difference between certainty factors of estimated intentions.

### CITATION LIST

### Patent Literature

Patent Literature 1: WO 2016/151698

### SUMMARY

### Technical Problem

Since, however, a conventional interaction system updates an utterance database by using a sentence input by a user of the system, it is not always possible to register an input sentence contributing to improvement of model accuracy in the utterance database.

As described above, the conventional interaction system has room for further improvement in terms of improving model identification accuracy.

Therefore, the present disclosure proposes an information processing device and an information processing method capable of further improving the model identification accuracy.

Note that the above-described problem or object is merely one of a plurality of problems or objects that can be solved or achieved by a plurality of embodiments disclosed in the present specification.

### Solution to Problem

According to the present disclosure, an information processing apparatus is provided. The information processing device includes a control unit. The control unit performs machine learning using positive example data and negative example data, and generates a model. The control unit calculates a correspondence rate that a plurality of pieces of example sentence data corresponds to an intention by using the model. The control unit selects presented data to be presented to a user from a plurality of pieces of example sentence data based on a predetermined threshold and a correspondence rate of the plurality of pieces of example sentence data. The control unit receives a determination of whether or not the presented data corresponds to the intention from the user. The control unit updates a predetermined threshold in accordance with a determination result.

### BRIEF DESCRIPTION OF DRAWINGS

FIG. 1 outlines an information processing method according to the technology of the present disclosure.

FIG. 2 is a block diagram illustrating a configuration example of an information processing system according to a first embodiment of the present disclosure.

FIG. 3 illustrates a case where an utterance identification unit according to the first embodiment of the present disclosure identifies an intention of an utterance of a user.

FIG. 4 illustrates a presentation example of example sentence data according to the first embodiment of the present disclosure.

FIG. 5 illustrates another presentation example of the example sentence data according to the first embodiment of the present disclosure.

FIG. 6 illustrates a threshold according to the first embodiment of the present disclosure.

FIG. 7 illustrates the threshold according to the first embodiment of the present disclosure.

FIG. 8 illustrates the threshold according to the first embodiment of the present disclosure.

FIG. 9 is a flowchart illustrating one example of update processing performed by the information processing system according to the first embodiment of the present disclosure.

FIG. 10 is a flowchart illustrating the processing of updating the threshold with an update unit according to the first embodiment of the present disclosure.

FIG. 11 illustrates a presentation example of example sentence data according to a second embodiment of the present disclosure.

FIG. 12 illustrates a presentation example of utterance data according to a third embodiment of the present disclosure.

FIG. 13 illustrates one example of relearning processing according to a fourth embodiment of the present disclosure.

### DESCRIPTION OF EMBODIMENTS

Embodiments of the present disclosure will be described in detail below with reference to the accompanying drawings. Note that, in the present specification and the drawings, components having substantially the same functional configuration are denoted by the same reference signs, and redundant description thereof will be omitted.

Furthermore, in the present specification and the drawings, similar components of the embodiments may be distinguished by attaching different alphabetical characters after the same reference signs. Note, however, that, when it is unnecessary to particularly distinguish similar components, only the same reference signs are attached.

One or a plurality of embodiments (including examples and variations) described below can be implemented independently. In contrast, at least a part of the plurality of embodiments described below may be appropriately combined with at least a part of other embodiments. The plurality of embodiments may include different novel features. Therefore, the plurality of embodiments may contribute to solving different objects or problems, and may exhibit different effects.

Note that the description will be given in the following order.
1. Outline of Present Disclosure
1.1. Background
1.2. Outline of Proposed Technology
2. First Embodiment
2.1. System Configuration Example
2.2. Example of Information Processing
3. Second Embodiment
4. Third Embodiment
5. Fourth Embodiment
6. Other Embodiments
7. Conclusion

### 1. Outline of Present Disclosure

### 1.1. Background

Technology according to the present embodiments relates to an interaction system. The interaction system refers to a system that exchanges some information (interacts) with a service user (hereinafter, also simply referred to as user). For example, a natural language using text, an utterance, and the like is used for the exchange, but this is not a limitation. Gesture, eye contact, and the like may be used.

Service is provided to a user by using the interaction system. The service may be provided via a dedicated device such as a smart speaker and a robot, or may be provided as a GUI like an application of a smartphone.

The interaction system includes a system for calling a function prepared in the system corresponding to text input by the user. In order to call the function, the interaction system first estimates an utterance intention of the text (utterance) input by the user. When the estimated utterance intention is a call of the function, the interaction system calls the function, and provides the function to the user.

In such an interaction system, in order to estimate an utterance intention, an N-gram model is constructed by using a predefined intention and an utterance example corresponding thereto. For example, JP 2011-033680 A discloses a method in which utterance input by a user is used for estimating an intention by calculating an occurrence probability by using a learned N-gram model and addressing the occurrence probability as a probability that the utterance corresponds to the intention.

Furthermore, another system for estimating an utterance intention also adopts an approach of calculating a probability that an utterance corresponds to the intention by calculating a feature amount derived from a sentence from a plurality of positive example utterances and a plurality of negative example utterances and learning a binary classification model such as logistic regression by using the feature amount.

In either case, accuracy of estimating an utterance intention somewhat depends on the amount and quality of preliminarily prepared utterance examples. In particular, this is considered to be remarkable in a model using a machine learning identifier as in the latter case.

Collection of utterance examples for estimating an intention is performed by an approach of collection by preparing questions and causing a large number of unspecified subjects to perform input or an approach of collection performed by language experts.

In the collection performed by language experts, changed phrases can be collected without bias in variations, and utterances can be collected on a consistent standard. In contrast, limitation on the number of the language experts may lead to limitation on the number of collectable utterances or difficulty in continuously collecting utterances by continuously focusing on a specific system.

In particular, when various utterance support functions are continuously maintained in accordance with an actual use method and the content of service that can be provided, it may be more difficult to secure resources of language experts.

Furthermore, the collection using questions has an advantage that a large number of utterances are easily collected by a method such as simultaneously requesting a large number of unspecified people to collect utterances. In contrast, preparing an utterance standard for estimating an intention from the faces of limited questions is difficult. For example, a positive example utterance prepared by a certain subject may correspond to a negative example in view of a standard of another subject.

Moreover, collected utterances may be biased to examples evoked from examples in questions, and fail to contribute to improvement of accuracy of estimating an intention. As described above, the collection using questions has problems that variations of conceivable utterance examples are limited since subjects are not language experts and that utterance examples are influenced by prepared questions, for example.

In order to practically operate the interaction system, it is considered desirable that a small number of non-experts collect utterance examples that contribute to improvement of accuracy of estimating an intention from the viewpoint of standardizing utterance examples and the viewpoint of limited resources of language experts.

Another example of collecting utterance examples includes a method in which utterance examples are collected from users in order to reduce a burden of collecting utterance examples. For example, in WO 2016/151698 above, the system estimates an intention by using a model for estimating an intention from databases of utterances and intentions and a rephrasing result based on a rule from a sentence input by a user. Moreover, the system confirms the intention with the user in accordance with the certainty factor of the estimated intention, and updates an utterance database.

The system as described above updates the database based on an actual utterance of a user, and thus improves a model accuracy after the start of operation of actual service. In contrast, there is a demand for improving the model accuracy before the start of operation of actual service. In contrast, for example, a method in which only users perform use at the stage of a prototype can be considered. In this method, however, utterances input by the users (hereinafter, referred to as input utterances) may be biased to the utterances in accordance with system instruction.

Furthermore, when users select utterance candidates as in the above-described system, an expert review is demanded at the time when the input utterance is finally reflected in utterance examples of the functions of the entire system.

More specifically, when input utterances are actually collected as in the above-described system, it is considered that problems such as bias of utterance examples and lack of unity of standards occur as in a case where utterances are collected from a large number of unspecified users by using a question.

Furthermore, in the above-described system, a part of the input utterance is rephrased in accordance with a rule. Therefore, rephrasing that is not referred in the rule cannot be performed. As described above, collected utterances are limited to those based on the rule, so that the types of utterances are also limited by the rule. Furthermore, the presence of idioms and different phrases used depending on the type of intention is assumed. Therefore, knowledge and labor of experts are required for the maintenance of the rule each time the type of intention is added and adjusted.

As described above, even when utterances are collected from users, resources of language experts may be continuously required.

Furthermore, the above-described system uses the difference of the certainty factor between an intention having the first highest certainty factor and an intention having the second highest certainty factor as a determination standard for inquiring of a user. Here, for example, it is considered to increase the type of intention used for the determination standard, such as an intention having the third highest reliability and an intention having the fourth highest reliability. In such a case, if the number of types of utterances close to the intention having the first highest certainty factor increases, the possibility that utterances collected from users contributes to improvement of identification accuracy decreases.

Furthermore, since an utterance to be inquired of a user is selected based on certainty factors of estimating a plurality of intentions, adjustment of the number of intentions itself changes the utterance to be inquired of the user.

Furthermore, for example, JP 2006-215317 A discloses a system for collecting utterances from users. The system notifies the users that an utterance is rejected as not corresponding to an intention. The system adjusts an utterance acceptance range based on an utterance or an operation from the user.

Also in this system, however, similarly to the above-described system, utterances are collected from service users, so that utterance collection is limited as being performed after the start of operation of service.

Furthermore, users select candidates of utterances to be collected, so that an expert review is demanded at the time when the input utterance is finally reflected in utterance examples of the functions of the entire system similarly to the above-described system.

More specifically, when input utterances are actually collected as in the above-described system, it is considered that problems such as bias of utterance examples and lack of unity of standards occur as in a case where utterances are collected from a large number of unspecified users by using a question.

As described above, conventional systems have a problem in improvement of the model accuracy performed by users, who are not language experts, before the start of operation of service. In product design, a first impression given at the start of use of service is important. It is desirable to provide service with high accuracy in such a first impression.

Moreover, whether or not to call a function provided as service in accordance with a user utterance may be based on application of a specific linguistic definition, or on business judgment of a service provider.

For example, a case where a function of reading out a weather forecast is provided to a user as service will be considered. In this case, if a user utterance includes information on the weather which can be provided, the same weather forecast is read out in response to all the utterances.

In order to implement the function, in a certain system, a weather forecast includes a probability of precipitation, that is, the probability of precipitation is provided to users. In this case, when a user utterance includes information on the probability of precipitation, the system reads out a weather forecast in response to the utterance.

In contrast, in another system, a weather forecast does not include a probability of precipitation, that is, the probability of precipitation is not provided to users. In this case, it is desirable that, even when the user utterance includes information on the probability of precipitation, the system does not read out a weather forecast in response to the utterance.

As described above, it is assumed that, even when an utterance identification model supporting the function of reading out the same weather forecast is prepared, necessary settings are different depending on the functions to be provided. In this case, it is desirable to improve the accuracy of the utterance identification model and adjust a range of utterances to be identified before the start of operation of service.

Furthermore, in order to support functions added to the system every day and address adjustment of the functions to be provided in accordance with a situation as described above, it is desirable that a system developer can set the utterance acceptance range within a practical time.

As described above, a system in which, for example, a system developer who is neither a language expert nor a service user can improve the accuracy of an utterance identification model and adjust an utterance range in a relatively short time is desired.

### 1.2. Outline of Proposed Technology

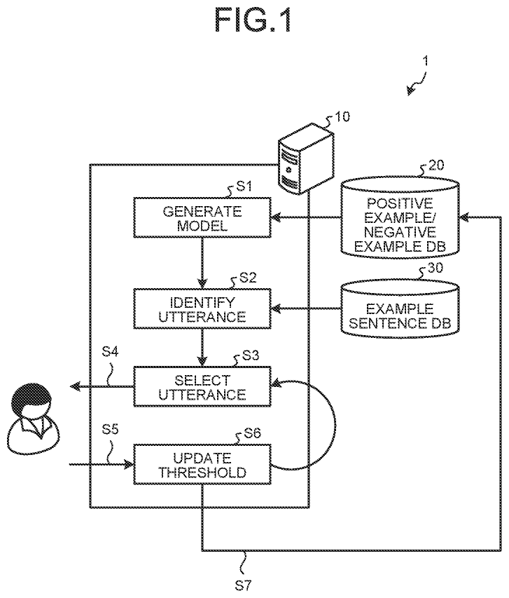

FIG. 1 outlines an information processing method according to the technology of the present disclosure. An information processing system 1 executes the information processing method according to the technology of the present disclosure.

As illustrated in FIG. 1, the information processing system 1 according to the technology of the present disclosure includes an information processing device 10, a positive example/negative example database (DB) 20, and an example sentence DB 30.

The positive example/negative example DB 20 is a storage device that stores an utterance that corresponds to a predetermined intention, that is, an utterance that is a positive example of the intention (hereinafter, also referred to as positive example data) and an utterance that does not correspond to the intention, that is, an utterance that is a negative example of the intention (hereinafter, also referred to as negative example data). The positive example/negative example DB 20 stores a smaller number of utterances than the example sentence DB 30.

The example sentence DB 30 is a storage device that stores utterances (hereinafter, also referred to as example sentence data) that can be uttered by a user. The utterances stored in the example sentence DB 30 include, for example, an utterance collected from a writing to a social network service (SNS) and the like, an utterance that has been mechanically edited based on another utterance, and an utterance that has been mechanically generated based on another utterance. The example sentence DB 30 is a large-scale utterance DB that stores an extraordinarily number of these utterances.

The information processing device 10 uses utterances stored in the positive example/negative example DB 20 and the example sentence DB 30 to generate a model for identifying whether or not a user utterance corresponds to a predetermined intention. Furthermore, the information processing device 10 updates the positive example/negative example DB 20 and adjusts a model identification range based on input from a system developer (hereinafter, also referred to as setting person) of the information processing system 1.

More specifically, the information processing device 10 performs machine learning by using positive example data and negative example data stored in the positive example/negative example DB 20, and generates an identification model (Step S1). Next, the information processing device 10 identifies a plurality of utterances (example sentence data) stored in the example sentence DB 30 by using the generated identification model (Step S2), and calculates a correspondence rate indicating a probability that the utterance corresponds to a predetermined intention.

Next, the information processing device 10 selects an utterance (hereinafter, also referred to as selected data) to be presented to the setting person from a plurality of utterances (example sentence data) identified by using the identification model based on a predetermined threshold and the calculated correspondence rate (Step S3). More specifically, the information processing device 10 selects, as the selected data, an utterance having a correspondence rate closest to the predetermined threshold.

The information processing device 10 presents the selected utterance (selected data) to the setting person (Step S4). The setting person determines whether or not the presented selected data corresponds to the predetermined intention, and inputs the data to the information processing device 10 (Step S5).

The information processing device 10 updates the predetermined threshold in accordance with a result of determination of correspondence/non-correspondence made by the setting person (Step S6).

The information processing device 10 returns to Step S3 until the predetermined number of determination results are acquired from the setting person, selects an utterance, and updates the threshold. The information processing device 10 that has acquired the predetermined number of determination results updates the positive example/negative example DB 20 by registering the selected utterance in the positive example/negative example DB 20 (Step S7). Furthermore, the information processing device 10 relearns the model by using the positive example data and the negative example data stored in the updated positive example/negative example DB 20.

As described above, the information processing device 10 can select an utterance with high learning efficiency by selecting an utterance which demands determination of the setting person based on the predetermined threshold.

Here, for example, the information processing device 10 updates the positive example/negative example DB 20 and relearns the model for each determination. In other words, the information processing device 10 omits Step S6 in FIG. 1, and updates the positive example/negative example DB 20 based on a result of input of the setting person in Step S5.

In this case, in order to collect utterances of the positive example/negative example DB in the number necessary for improving the accuracy of an identification model, processing in FIG. 1 is required to be repeated. It takes time to generate the identification model and identify an utterance as in Steps S1 and S2. It thus takes extraordinarily much time to collect the required number of utterances of the positive example/negative example DB.

Therefore, in the technology of the present disclosure, as described above, the information processing device 10 updates the threshold when the setting person determines an utterance. After the setting person makes the predetermined number of determinations, the information processing device 10 updates the positive example/negative example DB 20.

The information processing device 10 can shorten the time necessary for collecting utterances by updating the threshold. Furthermore, an utterance with high learning efficiency can be selected without relearning the model by selecting an utterance to be presented to the setting person by using the updated threshold. Note that details of updating a threshold will be described later.

As described above, the information processing system 1 according to the technology of the present disclosure can collect utterances with high learning efficiency, and can further improve a model identification accuracy.

### 2. First Embodiment

### 2.1. System Configuration Example

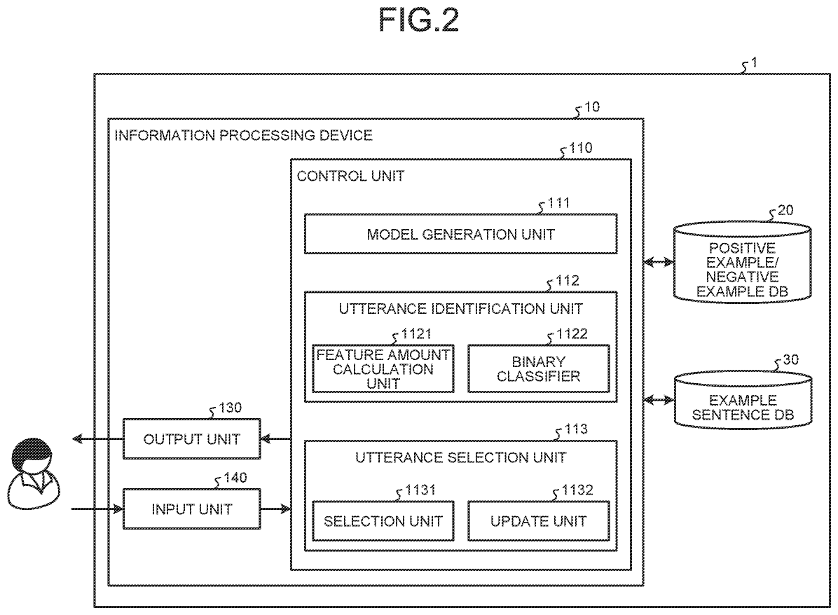

FIG. 2 is a block diagram illustrating a configuration example of the information processing system 1 according to a first embodiment of the present disclosure. The information processing system 1 in FIG. 2 includes the information processing device 10, the positive example/negative example DB 20, and the example sentence DB 30.

(Positive Example/Negative Example DB 20)

The positive example/negative example DB 20 is a storage device that stores utterance (positive example) data corresponding to an intention and utterance (negative example) data not corresponding to the intention. Here, although the positive example/negative example DB 20 is a device different from the information processing device 10, the positive example/negative example DB 20 may be a component (e.g., storage unit) of the information processing device 10.

The positive example/negative example DB 20 stores an extraordinarily small number of pieces of positive example data and negative example data as compared with the example sentence DB 30 to be described later. For example, the positive example data and the negative example data are stored in the positive example/negative example DB 20 by approximately 10 utterances each.

For example, a system developer (setting person) stores the positive example data and the negative example data in the positive example/negative example DB 20. Furthermore, the positive example data and the negative example data are added to the positive example/negative example DB 20 by update processing to be described later.

Here, the system developer who sets and adds the positive example data and the negative example data to the positive example/negative example DB 20 is a developer who develops a service system to be provided to a user, and is a language non-expert. As described above, in the present embodiment, the language non-expert sets and updates the positive example data and the negative example data.

(Example Sentence DB 30)

The example sentence DB 30 is a large-scale DB obtained by collecting a large amount of data on an utterance that can be uttered by a user. Here, although the example sentence DB 30 is a device different from the information processing device 10, the example sentence DB 30 may be a component (e.g., storage unit) of the information processing device 10.

The example sentence DB 30 is a database that stores a large number of, such as several hundreds of thousands of and several millions of, utterances. The utterances stored in the example sentence DB 30 are collected from, for example, web content, postings to social network service (SNS), a chat system, and an electronic mail system. Furthermore, the utterances stored in the example sentence DB 30 can include utterances mechanically edited or generated from other utterances, such as these collected utterances. For example, the example sentence data may be added to the example sentence DB 30 with a constant period. That is, the example sentence DB 30 can continuously collect, edit, or generate example sentence data.

(Information Processing Device 10)

The information processing device 10 provides a predetermined function in accordance with a user utterance. Furthermore, the information processing device 10 updates the positive example/negative example DB 20 and a model for identifying a user utterance by executing the update processing to be described later. Here, although the information processing device 10 is described as having predetermined functions, that is, both a function of identifying a user utterance and a function of executing the update processing, this is not a limitation. For example, the function of identifying a user utterance and the function of executing the update processing may be implemented in different devices.

The information processing device 10 in FIG. 2 includes a control unit 110, an output unit 130, and an input unit 140.

(Control Unit 110)

The control unit 110 is implemented by, for example, a central processing unit (CPU) and a micro processing unit (MPU) executing a program stored in the information processing device 10 by using a random access memory (RAM) or the like as a work area. Furthermore, the control unit 110 may be implemented by an integrated circuit such as an application specific integrated circuit (ASIC) and a field programmable gate array (FPGA).

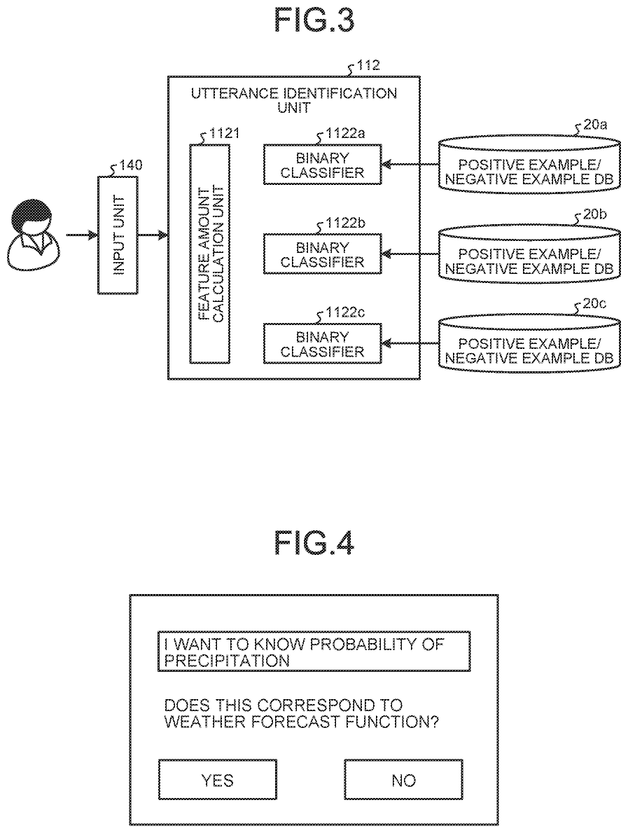

As illustrated in FIG. 2, the control unit 110 includes a model generation unit 111, an utterance identification unit 112, and an utterance selection unit 113. The control unit 110 implements or executes a function and an action of information processing to be described below. Note that the internal configuration of the control unit 110 is not limited to the configuration in FIG. 2. Another configuration may be adopted as long as the configuration performs the information processing to be described later. Furthermore, the connection relation between processing units of the control unit 110 is not limited to the connection relation in FIG. 3. Another connection relation may be adopted. Furthermore, each configuration of the control unit 110 may be implemented as another device.

(Model Generation Unit 111)

The model generation unit 111 performs machine learning by using positive example data and negative example data stored in the positive example/negative example DB 20, and generates a model. The model corresponds to a logic that is constructed based on so-called supervised learning and that recognizes utterance data input based on a predetermined algorithm. That is, the model can correspond to a “classifier”, a “recognizer”, a “discriminator”, and the like in the field of machine learning. Examples of the algorithm for achieving the above-described model include logistic regression and a support vector machine (SVM). Of course, these are merely examples. An algorithm for achieving the model is not particularly limited as long as an utterance intention can be recognized by a result of the machine learning.

In the example of FIG. 2, the model generation unit 111 generates a binary classifier 1122 by using the positive example data and the negative example data stored in the positive example/negative example DB 20 as the model. The generated model is used for identifying an utterance intention performed by the utterance identification unit 112.

(Utterance Identification Unit 112)

For example, after service starts to be provided, the utterance identification unit 112 identifies whether or not an utterance input by the user corresponds to an intention. Furthermore, the utterance identification unit 112 identifies whether or not the utterance stored in the example sentence DB 30 corresponds to the intention, for example, before the service starts to be provided or, for example, when the model and the positive example/negative example DB 20 are updated.

The utterance identification unit 112 includes a feature amount calculation unit 1121 and a binary classifier 1122.

The feature amount calculation unit 1121 has a function of calculating a feature amount (e.g., vector) from an utterance. For example, the feature amount calculation unit 1121 performs N-Gram analysis, and calculates the feature amount from the utterance. Alternatively, the feature amount calculation unit 1121 can calculate the feature amount from the utterance by using not only the above-described approach but various known techniques.

As described above, the binary classifier 1122 is a model achieved by an algorithm such as the logistic regression and the SVM. The binary classifier 1122 calculates a probability that an utterance corresponds to an intention based on the feature amount calculated by the feature amount calculation unit 1121. For example, when the feature amount of the utterance calculated by the feature amount calculation unit 1121 is input, the binary classifier 1122 outputs the probability that an utterance corresponds to an intention.

Here, a case where the utterance identification unit 112 identifies an intention of an utterance of a user will be described with reference to FIG. 3. FIG. 3 illustrates a case where the utterance identification unit 112 according to the first embodiment of the present disclosure identifies the intention of the utterance of the user. For example, when service of providing a function corresponding to an intention starts to be provided, the utterance identification unit 112 identifies the intention of the utterance of the user. Note that FIG. 3 illustrates only components necessary for description among components of the information processing system 1. Illustration of other components is omitted.

The utterance identification unit 112 includes one feature amount calculation unit 11121 and one or more binary classifiers 1122 for each intention to be identified. In the example of FIG. 3, the utterance identification unit 112 includes three binary classifiers 1122a to 1122c. The utterance identification unit 112 identifies which of three intentions an utterance input by the user corresponds to or whether or not the utterance does not correspond to any intention.

The utterance identification unit 112 receives an utterance from the user via the input unit 140. The feature amount calculation unit 1121 calculates a feature amount of the received utterance.

The binary classifiers 1122a to 1122c output a probability that the utterance corresponds to the intention by using the feature amount calculated by the feature amount calculation unit 1121 as input.

Here, the three binary classifiers 1122a to 1122c are models learned by the model generation unit 111 by using positive example/negative example DBs 20a to 20c in accordance with intentions to be identified.

For example, the binary classifier 1122a identifies whether or not an utterance corresponds to an intention A. The binary classifier 1122a is generated based on utterance data in which utterance data corresponding to the intention A is defined as positive example data and utterance data not corresponding to the intention A is defined as negative example data. The positive example data and the negative example data for the intention A are stored in, for example, a positive example/negative example DB 20a.

The binary classifier 1122a outputs a probability (correspondence rate) that a user utterance corresponds to the intention A.

Similarly, for example, the binary classifier 1122b identifies whether or not an utterance corresponds to an intention B. The binary classifier 1122b is generated based on utterance data in which utterance data corresponding to the intention B is defined as positive example data and utterance data not corresponding to the intention B is defined as negative example data. The positive example data and the negative example data for the intention B are stored in, for example, a positive example/negative example DB 20b.

The binary classifier 1122b outputs a probability (correspondence rate) that a user utterance corresponds to the intention B.

For example, the binary classifier 1122c identifies whether or not an utterance corresponds to an intention C. The binary classifier 1122c is generated based on utterance data in which utterance data corresponding to the intention C is defined as positive example data and utterance data not corresponding to the intention C is defined as negative example data. The positive example data and the negative example data for the intention C are stored in, for example, a positive example/negative example DB 20c.

The binary classifier 1122c outputs a probability (correspondence rate) that a user utterance corresponds to the intention C.

The utterance identification unit 112 compares a (correspondence rate) output by the binary classifiers 1122a to c with a predetermined value or more. The utterance identification unit 112 estimates that an intention corresponding to the binary classifier 1122 having a correspondence rate of a predetermined value or more is the intention of the utterance.

In this case, the control unit 110 can provide service to the user by calling a function corresponding to the intention estimated to correspond by the utterance identification unit 112.

Note that, when all the correspondence rates are less than the predetermined value, the utterance identification unit 112 estimates that the user utterance does not correspond to any intention. In this case, the control unit 110 can notify the user that, for example, there is no service that can be provided without providing service to the user. Alternatively, the control unit 110 may demand input the utterance again from the user.

Note that the predetermined value to be compared with the correspondence rate by the utterance identification unit 112 may be different or the same for each of the binary classifiers 1122a to c.

Furthermore, here, although three intentions are identified by the utterance identification unit 112, this is not a limitation. One, two, or four or more intentions may be identified by the utterance identification unit 112.

The description will return to FIG. 2. As described above, the utterance identification unit 112 identifies the intention of the utterance of the user, and calculates the correspondence rate indicating whether or not the utterance data (example sentence data) stored in the example sentence DB 30 corresponds to the intention. The utterance identification unit 112 stores the calculated correspondence rate in, for example, the example sentence DB 30 in association with the example sentence data.

Here, the example sentence DB 30 stores large-scale example sentence data. Therefore, it may take time if the utterance identification unit 112 calculates the correspondence rate of all pieces of example sentence data stored in the example sentence DB 30.

In this case, the feature amount calculation unit 1121 preliminarily calculates a corresponding embedded expression as a feature amount for all the pieces of example sentence data, and the binary classifier 1122 can calculate the correspondence rate for the embedded expression.

(Utterance Selection Unit 113)

The utterance selection unit 113 selects example sentence data based on the correspondence rate calculated by the utterance identification unit 112 and a predetermined threshold. The utterance selection unit 113 updates the predetermined threshold in accordance with whether or not the selected example sentence data (selected data) corresponds to the intention.

The utterance selection unit 113 includes a selection unit 1131 and an update unit 1132.

The selection unit 1131 compares the correspondence rate calculated by the utterance identification unit 112 with a predetermined threshold. The selection unit 1131 selects n (n is integer of one or more) pieces of example sentence data in the order from example sentence data having a correspondence rate closer to the predetermined threshold. Although a case of n=1, that is, a case where the selection unit 1131 selects example sentence data having a correspondence rate closest to the predetermined threshold will be described below, the selection unit 1131 may select two or more pieces of example sentence data.

Where there is a plurality of pieces of example sentence data having a correspondence rate closest to the predetermined threshold, the selection unit 1131 randomly selects one piece of example sentence data from the plurality of pieces of example sentence data, for example.

The selection unit 1131 presents the example sentence data selected via the output unit 130 to the user (setting person). FIG. 4 illustrates a presentation example of the example sentence data according to the first embodiment of the present disclosure.

FIG. 4 illustrates a case where, when the intention is “weather forecast function”, that is, “calling function of reading out weather forecast”, the selection unit 1131 selects “I want to know probability of precipitation” as the example sentence data.

The selection unit 1131 presents the example sentence data to the setting person by outputting an image including the example sentence data “I want to know probability of precipitation” having a correspondence rate closest to the predetermined threshold to the output unit 130, which is, for example, a display.

At this time, as illustrated in FIG. 4, the selection unit 1131 inquires of the setting person whether or not the example sentence data “I want to know probability of precipitation” corresponds to “weather forecast function”. The setting person selects whether or not the example sentence data selected by the selection unit 1131 corresponds to the intention. In FIG. 4, the setting person makes a selection as the example sentence data “I want to know probability of precipitation” corresponding to the intention “weather forecast function” (“Yes” in FIG. 4).

Note that, although, here, “I want to know probability of precipitation” corresponds to “weather forecast function”, this is not a limitation. For example, there is a case where “I want to know probability of precipitation” does not correspond to “weather forecast function”, such as a case where weather forecast service that can be provided to the user does not include the probability of precipitation. In this case, the setting person makes a selection as “I want to know probability of precipitation” not corresponding to “weather forecast function” (“No” in FIG. 4).

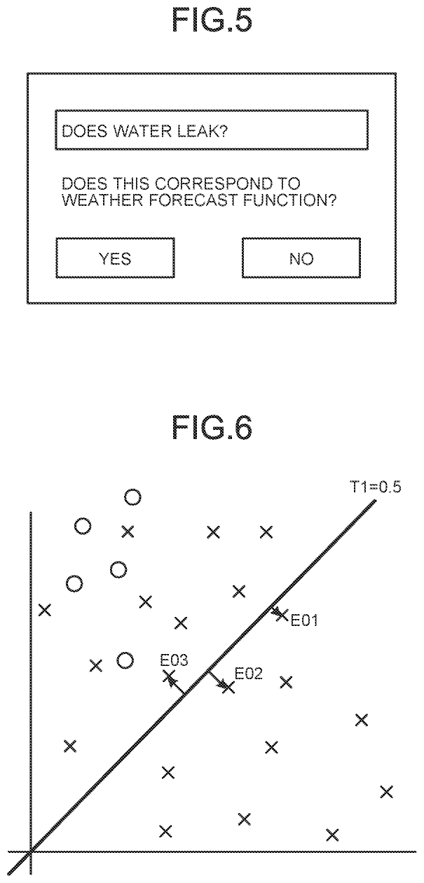

FIG. 5 illustrates another presentation example of the example sentence data according to the first embodiment of the present disclosure. FIG. 5 illustrates a case where the intention is “weather forecast function” and the example sentence data selected by the selection unit 1131 is “Does water leak?”. The selection unit 1131 presents the example sentence data to the setting person by, for example, outputting an image including the example sentence data “Does water leak?” to the output unit 130, which is a display.

The setting person selects whether or not the example sentence data selected by the selection unit 1131 corresponds to the intention. In FIG. 5, the setting person makes a selection as “Does water leak?” not corresponding to “weather forecast function” (“No” in FIG. 5).

The description will return to FIG. 2. As described above, the setting person selects whether or not the example sentence data selected by the selection unit 1131 corresponds to the intention, and inputs the selection to the information processing device 10 via the input unit 140.

In the information processing device 10 that has received the input from the setting person, the update unit 1132 updates the predetermined threshold in accordance with the input from the setting person.

Here, the predetermined threshold according to the first embodiment of the present disclosure will be described with reference to FIGS. 6 to 8. FIGS. 6 to 8 illustrate the threshold according to the first embodiment of the present disclosure.

First, the utterance selection unit 113 selects example sentence data to be presented to the setting person from example sentence data for which a correspondence rate has been calculated by setting a predetermined threshold t to t=T1=0.5 as an initial value.

For example, as illustrated in FIG. 6, the example sentence data can be mapped and represented in m-dimensional (m is integer of one or more) space by the feature amount calculated by the feature amount calculation unit 1121. Note that, although m is generally a high numerical value of several hundreds or more in practice, description will be made by setting m=2 here for the sake of explanation.

Note that, in FIG. 6, in order to facilitate the description, among pieces of example sentence data, pieces of example sentence data corresponding to the intention are represented by “o”, and pieces of example sentence data not corresponding to the intention are represented by “x”. The example sentence data according to the present embodiment is, however, an utterance randomly extracted from an SNS or the like or mechanically edited or generated. Whether or not the example sentence data corresponds to the intention is not distinguished.

The utterance identification unit 112 calculates the correspondence rate of an intention of each of the pieces of example sentence data in FIG. 6. For example, the pieces of example sentence data are divided into two data groups by a separate hyperplane of a threshold T1=0.5. The two data groups include a data group having a correspondence rate of 0.5 or more and a data group having a correspondence rate of less than 0.5.

In the case, example sentence data more away from the separate hyperplane of the threshold T1=0.5 has a higher probability that the example sentence data corresponds or does not correspond to the intention. The information processing device 10 easily identifies the example sentence data. In contrast, the closer the example sentence data is to the separate hyperplane of the threshold T1=0.5, the more difficult identification of the information processing device 10 is, which increases the possibility that an utterance intention is erroneously identified.

Therefore, the selection unit 1131 first selects example sentence data closest to the threshold T1=0.5, and presents the example sentence data to the setting person. For example, in FIG. 6, the selection unit 1131 selects example sentence data E01 closest to the separate hyperplane of the threshold T1=0.5 from pieces of example sentence data E01 to E03.

The setting person determines whether or not the example sentence data E01 corresponds to the intention, whereby the information processing device 10 can distinguish whether the example sentence data E01 that is difficult to be identified is the positive example data or the negative example data. Moreover, the information processing device 10 generates the model again by using the example sentence data E01 as the positive example data or the negative example data, whereby the accuracy of identification using the model can be improved.

If the information processing device 10 relearns the model and recalculates the correspondence rate of the example sentence data each time the setting person determines whether or not the example sentence data corresponds to the intention, the processing amounts of the relearning and the recalculation are greatly increased, and it takes time.

Furthermore, in an initial stage with a small number of pieces of positive example data and negative example data set in the positive example/negative example DB 20, example sentence data close to the separate hyperplane of the threshold T1=0.5 is highly likely not to correspond to the intention.

Therefore, in order to improve the model identification accuracy, the setting person is required to make a plurality of determinations. If the model is relearned and the correspondence rate is recalculated each time the setting person makes a determination, an extraordinarily large amount of cost is required.

Therefore, in the information processing device 10 according to the first embodiment of the present disclosure, the model is not relearned and the correspondence rate is not recalculated each time the setting person makes a determination. The update unit 1132 of the utterance selection unit 113 updates a predetermined threshold t each time a determination is made. More specifically, when the setting person determines that the presented example sentence data does not correspond to the intention, the update unit 1132 increases the threshold t. When the setting person determines that the example sentence data corresponds to the intention, the update unit 1132 decreases the threshold t.

The selection unit 1131 selects the example sentence data based on the updated threshold t, and presents the example sentence data to the setting person. The utterance selection unit 113 repeatedly selects example sentence data with the selection unit 1131 and updates the threshold t with the update unit 1132. The utterance selection unit 113 thereby acquires example sentence data to be added to the positive example/negative example DB 20 as the positive example data and the negative example data.

Here, update of the threshold t performed by the update unit 1132 will be described. As described with reference to FIG. 6, when there are a small number of pieces of positive example data and negative example data used for generating a model, example sentence data close to the separate hyperplane of the threshold t=0.5 is highly likely not to correspond to the intention.

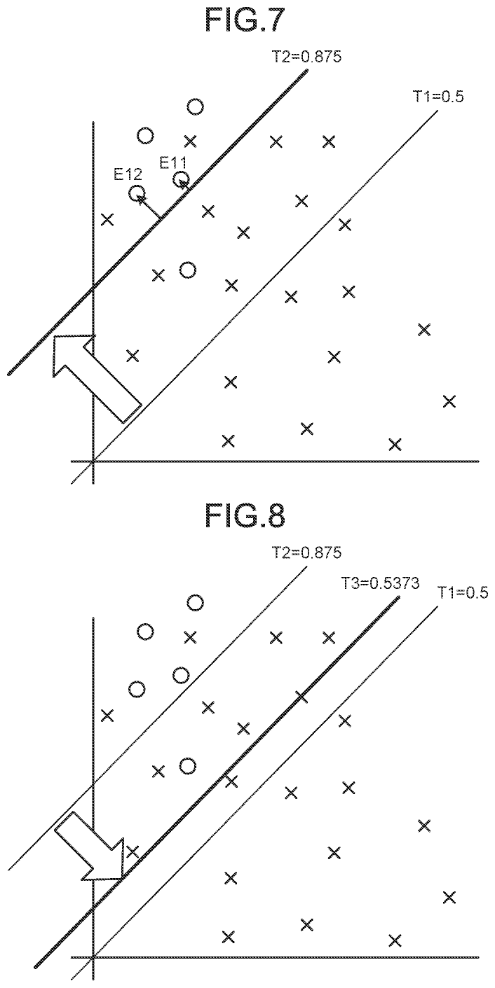

Therefore, when the setting person determines that the example sentence data E01 does not correspond to the intention, the update unit 1132 increases the value of the threshold t from, for example, T1=0.5 to T2=0.875 as illustrated in FIG. 7.

The selection unit 1131 selects example sentence data to be presented to the setting person based on an updated threshold T2=0.875. In the case, the correspondence rate of the example sentence data selected by the selection unit 1131 is higher than that in the case of the previous selection. Therefore, the example sentence data selected by the selection unit 1131 is more likely to be determined to correspond by the setting person than the example sentence data selected last time.

In the example of FIG. 7, the selection unit 1131 selects example sentence data E11 closest to the separate hyperplane of the threshold T2=0.875 from pieces of example sentence data E11 and E12 close to the separate hyperplane, and presents the example sentence data E11 to the setting person. The setting person determines that the example sentence data E11 corresponds to the intention.

The update unit 1132 decreases the threshold t from T2=0.875, and changes the threshold t to T3=0.5373 based on the determination of the setting person (see FIG. 8). As described above, the update unit 1132 changes the change rate of the threshold t in accordance with the number times of determinations made by the setting person, that is, the number of times of updates of the threshold t. More specifically, the update unit 1132 decreases the change rate of the threshold t as the number of times of updates increases. Therefore, as illustrated in FIG. 8, the threshold T3=0.5373 is located between T1=0.5 and T2=0.875.

As described above, the update unit 1132 updates the threshold t in accordance with the determination of the setting person, whereby the separate hyperplane of the threshold t can be brought closer to an interface between example sentence data corresponding to the intention and example sentence data not corresponding to the intention. Furthermore, the selection unit 1131 can select example sentence data close to such an interface by selecting the example sentence data based on the threshold t.

The utterance selection unit 113 adds the example sentence data selected by the selection unit 1131 to the positive example/negative example DB 20 in accordance with the determination of the setting person. This allows the utterance selection unit 113 to add the example sentence data close to the interface to the positive example/negative example DB 20 as the positive example data or the negative example data, and allows the information processing device 10 to relearns the model by using the positive example data and the negative example data close to the interface. Therefore, each time the setting person makes a determination, the information processing device 10 can collect the positive example data or the negative example data contributing to the improvement of the identification accuracy in a shorter time than that in the case where the model is relearned.

Note that the utterance selection unit 113 repeats update of the threshold t. Here, the number of times of repetitions of update of the threshold t will be described.

For example, the utterance selection unit 113 ends the update of the threshold t in accordance with a determination of the setting person, and updates the positive example/negative example DB 20. More specifically, the utterance selection unit 113 ends the update of the threshold t when the number of pieces of example sentence data determined to correspond by the setting person coincides with the number of pieces of example sentence data determined not to correspond.

Alternatively, the utterance selection unit 113 may end the update of the threshold t when, for example, the threshold t is updated a certain number of times.

(Output Unit 130)

The description will return to FIG. 2. The output unit 130 is a mechanism for outputting various pieces of information. The output unit 130 is a display. The output unit 130 displays example sentence data selected by the utterance selection unit 113. Note that the output unit 130 may be, for example, a speaker that reads out the example sentence data.

(Input Unit 140)

The input unit 140 is a device for receiving various operations from a user. For example, the input unit 140 is implemented by a keyboard, a mouse, a touch panel, and the like. The input unit 140 receives, for example, a determination result of whether or not the example sentence data displayed on the output unit 130 corresponds to an intention from the setting person, and outputs the determination result to the utterance selection unit 113.

Note that, although a case where the output unit 130 and the input unit 140 are components of the information processing device 10 has been described here, the output unit 130 and the input unit 140 may be devices different from the information processing device 10.

### 2.2. Example of Information Processing

Next, one example of information processing performed by the information processing system 1 according to the first embodiment of the present disclosure will be described.

(Relearning Processing)

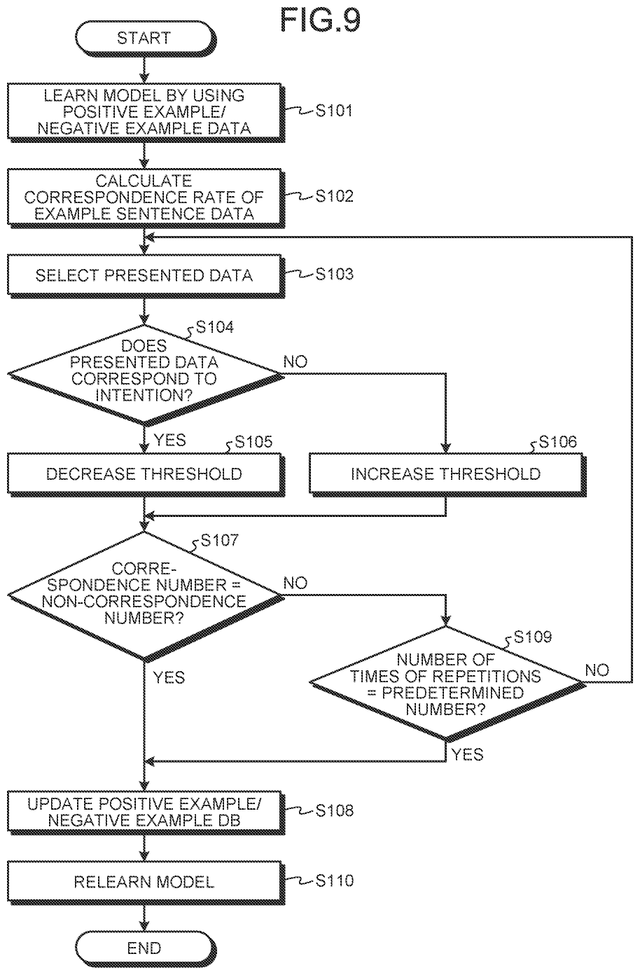

FIG. 9 is a flowchart illustrating one example of update processing performed by the information processing system 1 according to the first embodiment of the present disclosure. The information processing system 1 updates the positive example/negative example DB 20 and relearns a model by, for example, executing the update processing in FIG. 9.

First, the information processing system 1 learns a model by using the positive example data and the negative example data stored in the positive example/negative example DB 20 (Step S101). The information processing system 1 calculates a correspondence rate of example sentence data stored in the example sentence DB 30 by using the learned model (Step S102).

Subsequently, the information processing system 1 selects example sentence data (presented data) to be presented to the setting person from the example sentence data based on the correspondence rate (Step S103). More specifically, the information processing system 1 selects, as the presented data, the example sentence data having the correspondence rate closest to the predetermined threshold t.

The information processing system 1 determines whether or not a determination result from the setting person indicates that the presented data corresponds to an intention (Step S104). When the determination result from the setting person indicates that the presented data corresponds to an intention (Step S104; Yes), the information processing system 1 decreases the threshold t (Step S105). In contrast, when the determination result from the setting person indicates that the presented data does not correspond to the intention (Step S104; No), the information processing system 1 increases the threshold t (Step S106).

After updating the threshold t in Step S105 or S106, the information processing system 1 determines whether or not to again select the presented data and update the threshold t. More specifically, first, the information processing system 1 determines whether or not the number of pieces of presented data determined to correspond to the intention by the setting person (correspondence number) coincides with the number of pieces of presented data determined not to correspond to the intention (non-correspondence number) (Step S107).

When the correspondence number coincides with the non-correspondence number (Step S107; Yes), the information processing system 1 updates the positive example/negative example DB 20 (Step S108). More specifically, the presented data determined to correspond/not to correspond by the setting person is added to the positive example/negative example DB 20 in accordance with the determination result.

In contrast, when the correspondence number does not coincide with the non-correspondence number (Step S107; No), the information processing system 1 determines whether or not a predetermined number of times (of repetitions) the presented data is selected and the threshold t is updated (Step S109).

When the number of times of repetitions does not coincides with the predetermined number of times (Step S109; No), the processing returns to Step S103, and the information processing system 1 selects the presented data.

In contrast, when the number of times of repetitions coincides with the predetermined number of times (Step S109; Yes), the processing proceeds to Step S108, and the information processing system 1 updates the positive example/negative example DB 20.

Subsequently, the information processing system 1 relearns the model by using the positive example data and the negative example data stored in the updated positive example/negative example DB 20 (Step S110).

(Threshold Update Processing)

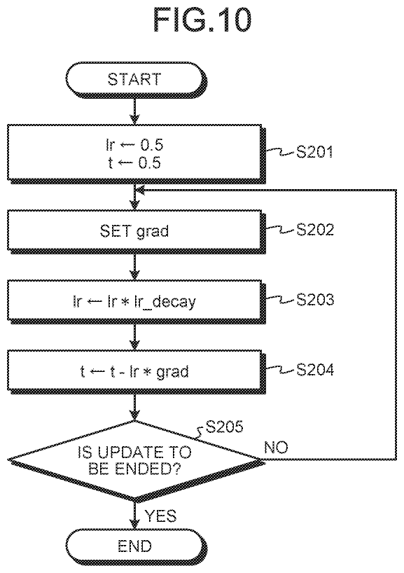

Next, processing of updating the threshold t with the update unit 1132 will be described. FIG. 10 is a flowchart illustrating the processing of updating the threshold t with the update unit 1132 according to the first embodiment of the present disclosure. The processing of updating the threshold t described with reference to FIG. 10 is processing mainly performed by the update unit 1132 among pieces of processing performed in Steps S103 to S109 of relearning processing in FIG. 9.

The update unit 1132 updates the threshold t by using, for example, a steepest gradient descent (SGD) method. Hereinafter, description will be given by setting an initial value of the threshold t to “0.5”, a learning ratio as “lr”, a learning rate decay as “lr_decay”, and a gradient equivalent value as “grad”.

Note that, since the correspondence rate of the example sentence data is a probability that the example sentence data corresponds to the intention, the range of possible values of the correspondence rate is zero or more and one or less, but the range of the threshold t is not limited to the range of zero or more and one or less. That is, the value of the threshold t may be temporarily less than zero or more than one.

Furthermore, an initial value of the learning ratio lr is, for example, “0.5”. The learning rate decay lr_decay is a fixed value, for example, “0.75”. The gradient equivalent value grad is set in accordance with a determination of the setting person.

As illustrated in FIG. 10, first, the update unit 1132 initializes the learning ratio lr and the threshold t. More specifically, the update unit 1132 substitutes “0.5”, which is the initial value, for each of the learning ratio lr and the threshold t (Step S201).

Next, the update unit 1132 sets the gradient equivalent value grad in accordance with the determination result of the example sentence data from the setting person (Step S202). More specifically, when the example sentence data is determined to correspond to the intention, the update unit 1132 sets the gradient equivalent value grad to one (grad<-1). When the example sentence data is determined not to correspond to the intention, the update unit 1132 sets the gradient equivalent value grad to −1 (grad<-−1).

The update unit 1132 decays the learning ratio lr. More specifically, the update unit 1132 replaces the learning ratio lr with a product of the learning ratio lr and the learning rate decay lr_decay (Step S203).

The update unit 1132 updates the threshold t with the product of the gradient equivalent value grad and the learning ratio lr. More specifically, the update unit 1132 replaces the threshold t with a value obtained by subtracting the product of the learning ratio lr and the gradient equivalent value grad from the threshold t (Step S204).

The update unit 1132 determines whether or not to end the update of the threshold t (Step S205). Since the end determination here is the same as the determination in Steps S107 and S109 in FIG. 9, the description thereof will be omitted.

When the update of the threshold t is continued (Step S205; No), the processing returns to Step S202. In contrast, when the update of the threshold t is ended (Step S205; Yes), the update unit 1132 ends the update processing.

Subsequently, the processing of updating the threshold t will be described by using a specific numerical example. Here, description will be given by setting the intention as “reading-out of weather forecast” and the number of times of repetitions determined in Step S109 as “10”.

First, the update unit 1132 initializes the learning ratio lr and the threshold t, and sets lr=0.5 and t=0.5. The selection unit 1131 is assumed to have selected “What's for dinner?” as the example sentence data having a correspondence rate closest to the threshold t=0.5. In this case, the setting person determines that the example sentence data does not correspond to the intention (non-correspondence).

The update unit 1132 sets “−1” to the gradient equivalent value grad in accordance with the determination result (non-correspondence)) from the setting person. The update unit 1132 decays the learning ratio lr. The update unit 1132 calculates a product of the learning ratio lr and the learning rate decay lr_decay (lr*lr_decay=0.5*0.75=0.375), and sets the calculated “0.375” as a new learning ratio lr.

The update unit 1132 updates the threshold t with the product of the gradient equivalent value grad=−1 and the learning ratio lr=0.375. More specifically, the update unit 1132 calculates t−lr*grad=0.5-0.375 (−1)=0.875, and sets the calculated “0.875” as a new threshold t.

Here, the number of pieces of example sentence data determined to correspond by the setting person (correspondence number) is “0”. The number of pieces of example sentence data determined not to correspond (non-correspondence number) is “1”. The correspondence number does not coincide with the non-correspondence number. Furthermore, the number of times the update unit 1132 has updated the threshold t is “1”, and the number does not coincide with the set number of times of repetitions “10”. Therefore, the update unit 1132 returns to Step S202, and continues the threshold update processing.

Next, it is assumed that the selection unit 1131 selects “What's the weather like today?” as example sentence data having a correspondence rate closest to the threshold t=0.875, and the setting person determines that the example sentence data corresponds to the intention (correspondence).

The update unit 1132 sets “1” to the gradient equivalent value grad in accordance with the determination result (correspondence) from the setting person. The update unit 1132 decays the learning ratio lr. The update unit 1132 calculates a product of the learning ratio lr and the learning rate decay lr_decay (lr*lr_decay=0.375*0.75=0.28125), and sets the calculated “0.28125” as a new learning ratio lr.

The update unit 1132 updates the threshold t with a product of the gradient equivalent value grad=1 and the learning ratio lr=0.28125. More specifically, the update unit 1132 calculates t−lr*grad=0.875-0.28125*1=0.59375, and sets the calculated “0.59375” as a new threshold t.

Here, the number of pieces of example sentence data determined to correspond by the setting person (correspondence number) is “1”. The number of pieces of example sentence data determined not to correspond (non-correspondence number) is “1”. The correspondence number coincides with the non-correspondence number. Therefore, the update unit 1132 ends the processing of updating the threshold t. The information processing device 10 adds, in the positive example/negative example DB 20, “What's for dinner?” as the negative example data and “What's the weather like today?” as the positive example data, and relearns the model.

Note that, in the specific example described here, the information processing device 10 newly collects two pieces of utterance data “What's for dinner?” and “What's the weather like today?”. In the above-described example, the number of times of repetitions determined in Step S109 (“10” in above-described example. Hereinafter, also referred to as repetition upper limit number) is set. In addition, a repetition lower limit number may be set. The repetition lower limit number is the minimum number of pieces of collected utterance data, in other words, the minimum number of times of repetitions of updating the threshold t.

Setting the repetition lower limit number as described above allows the information processing device 10 to add the repetition lower limit number or more pieces of utterance data in the positive example/negative example DB 20.

Note that, although, in the above-described threshold update processing, the update unit 1132 updates the threshold t by using SGD, a method of updating the threshold t is not limited thereto. The update unit 1132 can update the threshold t by using various existing methods. For example, the update unit 1132 may update the threshold t by using momentum.

In this case, the update unit 1132 updates the threshold t by using a variable v and a constant momentum factor (mf). An initial value of the variable v is, for example, “0”. Furthermore, for example, mf=0.9 is established for the value of the constant mf.

The update unit 1132 updates the threshold t by using the variable v and the constant mf instead of updating the threshold t in Step S204 in FIG. 10. First, the update unit 1132 updates the variable v by using the constant mf, the learning ratio lr, and the gradient equivalent value grad. More specifically, the update unit 1132 calculates mf*v−lr grad, and sets the calculated value as a new variable v (v<−mf*v−lr grad).

Next, the update unit 1132 updates the threshold t by using the updated variable v. More specifically, a value obtained by subtracting the variable v from the threshold t is set as a new threshold t (t<−t−v).

SGD and momentum described above are approaches of optimizing a variable by using gradient descent. In addition, the information processing device 10 may update the threshold t by using a gradient descent method such as AdaGrad, Adam, or AdaBoun.

As described above, the information processing device 10 according to the first embodiment of the present disclosure includes the control unit 110. The control unit 110 performs machine learning using the positive example data and the negative example data, and generates the binary classifier 1122 (one example of model). The control unit 110 calculates a correspondence rate that a plurality of pieces of example sentence data corresponds to an intention by using the binary classifier 1122. The control unit 110 selects presented data (one example of selected data) to be presented to the setting person from the plurality of pieces of example sentence data based on the predetermined threshold t and the correspondence rates of the plurality of pieces of example sentence data. The control unit 110 receives a determination of whether or not the presented data corresponds to the intention from the setting person (one example of user). The control unit 110 updates the threshold t in accordance with the determination result.

This allows the information processing device 10 to collect utterance data for improving the accuracy of the binary classifier 1122 in a shorter time, which can further improve the accuracy of the binary classifier 1122.

Furthermore, the control unit 110 of the information processing device 10 selects the presented data again by using the updated predetermined threshold t.

This allows the information processing device 10 to collect utterance data that can contribute to improvement of the accuracy of the binary classifier 1122 in a shorter time, which can further improve the accuracy of the binary classifier 1122.

Furthermore, when the number of pieces of presented data determined to correspond to the intention by the setting person (correspondence number) coincides with the number of pieces of presented data determined not to correspond to the intention (non-correspondence number), the control unit 110 of the information processing device 10 ends the update of the predetermined threshold t.

This allows the information processing device 10 to collect utterance data that can contribute to improvement of the accuracy of the binary classifier 1122 in a shorter time, which can further improve the accuracy of the binary classifier 1122.

Furthermore, the control unit 110 of the information processing device 10 ends the update of the predetermined threshold t when the setting person makes a predetermined number of times of determinations.

This allows the information processing device 10 to collect a predetermined number of piece of utterance data in a shorter time, which can improve the accuracy of the binary classifier 1122 in a shorter time.

Furthermore, the control unit 110 of the information processing device 10 performs machine learning again by adding the presented data determined to correspond to the intention by the setting person in the positive example data and adding the presented data determined not to correspond to the intention by the setting person in the negative example data, and generates the binary classifier 1122.

This allows the information processing device 10 to collect utterance data that can contribute to improvement of the accuracy of the binary classifier 1122 in a shorter time, which can further improve the accuracy of the binary classifier 1122.

Furthermore, when the presented data is determined to correspond to the intention, the control unit 110 of the information processing device 10 updates the predetermined threshold t to a smaller value.

Furthermore, when the presented data is determined not to correspond to the intention, the control unit 110 of the information processing device 10 updates the predetermined threshold t to a larger value.

This allows the information processing device 10 to collect utterance data that can contribute to improvement of the accuracy of the binary classifier 1122 in a shorter time, which can further improve the accuracy of the binary classifier 1122.

### 3. Second Embodiment

Although, in the above-described first embodiment, the setting person determines whether or not the example sentence data selected by the utterance selection unit 113 corresponds to the intention, this is not a limitation. For example, the setting person may be allowed to select the third option in addition to whether or not the example sentence data correspond to the intention. Therefore, in a second embodiment, a case where the information processing device 10 receives selection of the third option in addition to correspondence/non-correspondence for the selected example sentence data will be described.

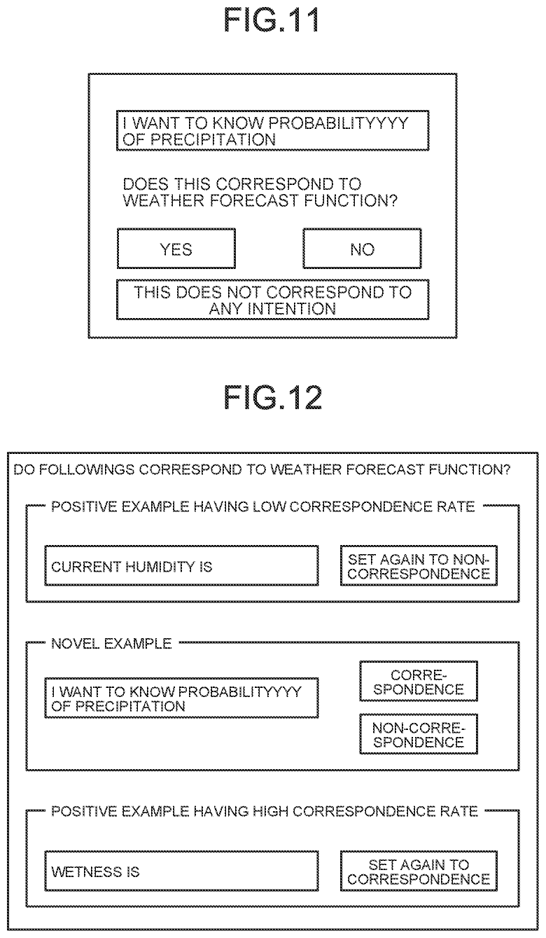

FIG. 11 illustrates a presentation example of the example sentence data according to the second embodiment of the present disclosure. When selecting example sentence data having a correspondence rate closest to the predetermined threshold t, the utterance selection unit 113 presents the selected example sentence data to the setting person via the output unit 130.

The utterance selection unit 113 presents the example sentence data, inquires whether or not the example sentence data corresponds to the intention, and receives a determination result from the setting person. In the case, the utterance selection unit 113 receives the selection of the third option of “This does not correspond to any intention” from the setting person in addition to correspondence/non-correspondence.

That is, as illustrated in FIG. 11, the utterance selection unit 113 presents the option of “This does not correspond to any intention” to the setting person in addition to options for the setting person to select correspondence to the intention (“Yes” in FIG. 11) and non-correspondence (“No” in FIG. 11).

Here, as described above, the function provided by the information processing device 10 to a user is not limited only to the function for the intention identified by the binary classifier 1122. Other functions may be provided. For example, as illustrated in FIG. 3, the information processing device 10 may provide a function for a plurality of intentions to the user.

In such a case, when the setting person recognizes such a plurality of intentions, the setting person can determine that the presented example sentence does not correspond not only to the intention identified by the binary classifier 1122 to be relearned this time but to other intentions.

For example, in FIG. 3, the information processing device 10 executes relearning processing in order to relearn the binary classifier 1122a. In the case, as illustrated in FIG. 11, the information processing device 10 presents an option of “This does not correspond to any intention” to the setting person, whereby the information processing device 10 can collect information that the presented example sentence data does not correspond to the intentions identified by the binary classifiers 1122b and 1122c.

In this case, the information processing device 10 may add the presented example sentence data as negative example data in the positive example/negative example DB 20a and also in the positive example/negative example DBs 20b and 20c. This allows the information processing device 10 to update the plurality of positive example/negative example DBs 20 at a time.

Alternatively, in the first place, the example sentence data to be presented may fail to be present as an utterance. As described above, the example sentence data stored in the example sentence DB 30 is collected from an SNS and the like, or mechanically edited or generated. Therefore, the example sentence data may include data that is merely a list of characters and is not established as an utterance sentence and an utterance that may be discriminatory or may cause a problem from the viewpoint of compliance.

It is considered that such example sentence data is inappropriate for identification with the binary classifier 1122 in the first place, and should not be received as an utterance. Therefore, the information processing device 10 according to the present embodiment receives, as the third option (“This does not correspond to any intention”), a determination that the example sentence data does not correspond to any intention in the first place in addition to intentions corresponding to a function of providing service.

In this case, when receiving a determination that the example sentence data corresponds to the third option from the setting person, the information processing device 10 updates the example sentence DB 30 so that the example sentence data is not used for identification in the binary classifier 1122. For example, the information processing device 10 stores the example sentence data and information (flag) indicating that the example sentence data is not used for calculating a correspondence rate in the example sentence DB 30 in association with each other.

Note that, when the setting person selects the third option, the update unit 1132 can update the threshold t similarly in the case where the setting person selects non-correspondence. Alternatively, the selection unit 1131 may select the example sentence data again without the update unit 1132 updating the threshold t. In this case, for example, the selection unit 1131 selects example sentence data having a correspondence rate second closest to the threshold t as data to be presented to the setting person.

Furthermore, in order to make the determination in Step S107, the information processing device 10 may add the number of pieces of example sentence data for which the third option has been selected as the number of pieces of example sentence data determined not to correspond to the intention. That is, when the example sentence data is selected as corresponding to the third option, the information processing device 10 may increase the non-correspondence number by one.

Alternatively, the number of pieces of example sentence data for which the third option has been selected is not required to be added to the correspondence number or the non-correspondence number. That is, when the example sentence data is selected as corresponding to the third option, the information processing device 10 may cause both the correspondence number and the non-correspondence number not to be increased.

Furthermore, in order to make the determination in Step S109, the information processing device 10 may add or is not required to add the number of pieces of example sentence data for which the third option has been selected to the number of times of repetitions.

As described above, the information processing device 10 according to the second embodiment of the present disclosure receives the third option from the setting person in addition to the option of selecting whether or not the example sentence data corresponds to the intention. The third option is provided for selecting that the example sentence data does not correspond to a plurality of intentions. The example sentence data for which the third option has been selected is excluded from a plurality of pieces of example sentence data used for identification in the binary classifier 1122.

This allows the information processing device 10 to reduce unnecessary identification in the binary classifier 1122, which can improve the accuracy of the binary classifier 1122 in a shorter time.

Alternatively, the information processing device 10 may add the example sentence data for which the third option has been selected in the positive example/negative example DB 20 as negative example data. This allows the information processing device 10 to update the plurality of positive example/negative example DB 20, which can improve the accuracy of the binary classifier 1122 in a shorter time.

### 4. Third Embodiment

Although, in the second embodiment, a case where the third option is presented for the example sentence data selected by the utterance selection unit 113 has been described, this is not a limitation. For example, the information processing device 10 may present the positive example data and the negative example data to the setting person. Therefore, in a third embodiment, a case where the information processing device 10 presents positive example data having a low correspondence rate and negative example data having a high correspondence rate to the setting person will be described.

In this case, the utterance identification unit 112 of the information processing device 10 calculates not only the example sentence data stored in the example sentence DB 30 but the correspondence rates of the positive example data and the negative example data stored in the positive example/negative example DB 20.

The selection unit 1131 selects example sentence data having a correspondence rate closest to the predetermined threshold t, and selects the positive example data having the lowest correspondence rate and negative example data having the highest correspondence rate. The selection unit 1131 presents these pieces of data to the setting person.

FIG. 12 illustrates a presentation example of the utterance data according to the third embodiment of the present disclosure. The selection unit 1131 presents the example sentence data having a correspondence rate closest to the predetermined threshold t to the setting person. In the example in FIG. 12, the example sentence data is “I want to know probabilityyyy of precipitation”. The selection unit 1131 presents the example sentence data to the setting person as a “novel example”. The selection unit 1131 receives selection of the setting person of whether or not the presented example sentence data corresponds to the intention.

Furthermore, the selection unit 1131 presents the positive example data having the lowest correspondence rate to the setting person. In the example in FIG. 12, the selection unit 1131 presents “Current humidity is” as a positive example having a low correspondence rate. The selection unit 1131 receives selection of the setting person, which indicates that the presented positive example data does not correspond to the intention.

Similarly, the selection unit 1131 presents the negative example data having the highest correspondence rate to the setting person. In the example in FIG. 12, the selection unit 1131 presents “Wetness is” as a negative example having a high correspondence rate. The selection unit 1131 receives selection of the setting person, which indicates that the presented negative example data corresponds to the intention.

For example, a setting person who sets the positive example data and the negative example data in the positive example/negative example DB 20 may be different from a setting person who relearns the binary classifier 1122. In this case, an identification standard of the setting person who sets the positive example/negative example DB 20 may be different from an identification standard of the setting person who performs relearning.

Alternatively, a service function to be applied to a user may be partially changed, and thus an utterance that has corresponded to the intention so far may fail to correspond to the intention. For example, when a probability of precipitation has been read out so far as a function of reading out a weather forecast, but the probability of precipitation is not read out in the changed function, an utterance of “I want to know probability of precipitation” does not correspond to the intention of “reading-out of weather forecast”.

As described above, when the identification standard in the binary classifier 1122 changes, it may be more appropriate to set again the utterance data set as positive example data in the positive example/negative example DB 20 to negative example data. Alternatively, it may be more appropriate to set again the utterance data set as negative example data in the positive example/negative example DB 20 as positive example data.

Therefore, the information processing device 10 according to the present embodiment presents positive example data having a low correspondence rate to the setting person. When the setting person determines that the presented positive example data does not correspond to the intention, the information processing device 10 sets again the positive example data in the positive example/negative example DB 20 as utterance data (negative example data) not corresponding to the intention.

Furthermore, the information processing device 10 according to the present embodiment presents negative example data having a low correspondence rate to the setting person. When the setting person determines that the presented negative example data corresponds to the intention, the information processing device 10 sets again the negative example data in the positive example/negative example DB 20 as utterance data (positive example data) corresponding to the intention.

As described above, the information processing device 10 can set again the positive example data and the negative example data. The information processing device 10 can adjust the range of utterances identified by the binary classifier 1122, and further improve identification accuracy.

Note that, here, the information processing device 10 selects the positive example data and the negative example data one by one, and presents the data to the setting person. In contrast, the example sentence data is selected each time the threshold t is updated.

Although, in the example in FIG. 12, the positive example data, the example sentence data, and the negative example data are presented in parallel, the example sentence data (“I want to know probabilityyyy of precipitation”) is updated each time the setting person selects “correspondence” or “non-correspondence”, and new example sentence data is presented.

Note that, although the information processing device 10 presents the positive example data having the lowest correspondence rate and the negative example data having the highest correspondence rate here, this is not a limitation. For example, either one of the positive example data having the lowest correspondence rate and the negative example data having the highest correspondence rate may be presented.

Alternatively, the information processing device 10 may present d1 (d1 is integer of two or more) pieces of positive example data in ascending order of the correspondence rate, or may present d2 (d2 is integer of two or more) pieces of negative example data in descending order of the correspondence rate. As described above, the information processing device 10 may present not only one piece of positive example data or negative example data but a plurality of pieces of data.

Furthermore, although, in FIG. 12, the information processing device 10 presents the positive example data, the example sentence data, and the negative example data in parallel on one screen, this is not a limitation. For example, the information processing device 10 may present the example sentence data, the positive example data, and the negative example data as different screens to the setting person. Alternatively, the positive example data, the example sentence data, and the negative example data may be presented on different screens.

In this case, for example, the information processing device 10 may first present the example sentence data. The information processing device 10 may end the update of the threshold t, that is, may end the collection of the example sentence data. The information processing device 10 may then set the positive example data and the negative example data again. Alternatively, the information processing device 10 may collect the example sentence data for updating the positive example/negative example DB 20 after setting the positive example data and the negative example data again.

As described above, the information processing device 10 according to the third embodiment of the present disclosure changes the positive example data having a small correspondence rate to the negative example data in accordance with the determination of the setting person. Furthermore, the information processing device 10 changes the negative example data having a large correspondence rate to the positive example data in accordance with the determination of the setting person.

This allows the information processing device 10 to adjust the range of utterances identified by the binary classifier 1122 and further improve identification accuracy.

### 5. Fourth Embodiment

Although, in the above-described first to third embodiments, a case where the binary classifier 1122 (model) is relearned after the utterance selection unit 113 ends the update of the threshold t has been described, this is not a limitation. For example, the information processing device 10 may update the threshold t, in other words, may collect new positive example data and negative example data and relearn the binary classifier 1122 in parallel. Therefore, in the fourth embodiment, a case where the information processing device 10 collects new positive example data and negative example data and relearns the binary classifier 1122 in parallel will be described.

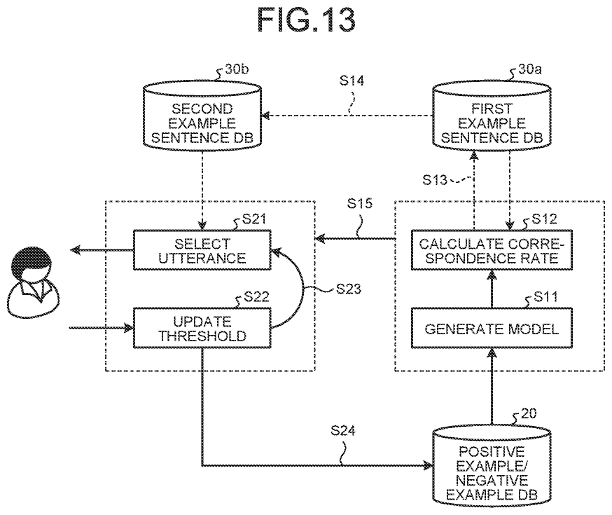

FIG. 13 illustrates one example of relearning processing according to a fourth embodiment of the present disclosure. Note that description of the same processing as the relearning processing according to the first embodiment will be omitted. The information processing system 1 according to the present embodiment includes a first example sentence DB 30a and a second example sentence DB 30b.

First, the information processing device 10 performs machine learning using positive example data and negative example data stored in the positive example/negative example DB 20, and generates the binary classifier 1122 (model) (Step S11).

The information processing device 10 calculates a probability (correspondence rate) that the example sentence data stored in the first example sentence DB 30a corresponds to an intention (Step S12). The information processing device 10 stores the calculated correspondence rate in the first example sentence DB 30a in association with the example sentence data (Step S13).

The information processing device 10 stores (copies) information stored in the first example sentence DB 30a into the second example sentence DB 30b (Step S14). When processing of collecting the positive example data and the negative example data is being performed, the information processing device 10 temporarily interrupts the collection processing. The information processing device 10 performs copying from the first example sentence DB 30a to the second example sentence DB 30b. After completion of the copying, the information processing device 10 resumes the collection processing.

When the processing of collecting the positive example data and the negative example data is not being performed, the information processing device 10 performs the collection processing (Step S15).

More specifically, the information processing device 10 selects example sentence data (utterance) having a correspondence rate closest to the threshold t from example sentence data stored in the second example sentence DB 30b (Step S21).

The information processing device 10 updates the threshold t in accordance with a determination result from the setting person (Step S22). A method of updating the threshold t is the same as the update method according to the first embodiment.

The information processing device 10 repeats Steps S21 and S22 (Step S23). For example, the information processing device 10 repeats Steps S21 and S22 until collection of a predetermined number of pieces of positive example data or negative example data is completed. Alternatively, when a model is being relearned and a correspondence rate of example sentence data is being recalculated, the information processing device 10 repeats Steps S21 and S22 and collects the positive example data or the negative example data until the recalculation of the correspondence rate is completed.

The information processing device 10 updates the positive example/negative example DB 20 by adding the collected positive example data and negative example data to the positive example/negative example DB 20 (Step S24).

After updating the positive example/negative example DB 20, the information processing device 10 returns to Step S11, and generates a model.

When updating the positive example/negative example DB 20 in response to the completion of collection of a predetermined number of pieces of positive example data and negative example data, the information processing device 10 returns to Step S21. The information processing device 10 repeats Steps S21 and S22 to collect the positive example data or the negative example data until the recalculation of the correspondence rate is completed.

In contrast, when updating the positive example/negative example DB 20 in response to the completion of recalculation of the correspondence rate, the information processing device 10 returns to Step S21 after the copying of the second example sentence DB 30b in Step S13 is completed, and collects the positive example data or the negative example data.

Note that the information processing device 10 may relearn the model a predetermined number of times or the number of times that can be executed in a predetermined period.

Furthermore, although the information in the first example sentence DB 30a is copied into the second example sentence DB 30b here, this is not a limitation. For example, the information processing device 10 may alternately switch a storage destination of the correspondence rate in Step S13 between the first example sentence DB 30a and the second example sentence DB 30b. In this case, the information processing device 10 selects example sentence data to be presented to the setting person from the example sentence DB 30 in Step S21. The correspondence rate is stored in the example sentence DB 30 in Step S13.

As described above, the information processing device 10 according to the fourth embodiment of the present disclosure performs the model relearning processing and the processing of collecting positive example data or negative example data in parallel. This allows the information processing device 10 to further improve the model identification accuracy in a shorter time.

### 6. Other Embodiments

The processing according to each of the above-described embodiments may be carried out in various different forms other than each of the above-described embodiments.

Although, in each of the above-described embodiments, the setting person, who is a system developer, determines whether or not example sentence data corresponds to an intention, this is not a limitation. For example, a user of service provided by the information processing system 1 may make the determination.

As described in each of the above-described embodiments, the information processing device 10 updates the threshold t while the user determines the selected example sentence data. This allows the information processing device 10 to collect utterance data that can contribute to improvement of the model identification accuracy in a shorter time.

Furthermore, among pieces of processing described in each of the above-described embodiments, all or part of the processing described as being performed automatically can be performed manually, or all or part of the processing described as being performed manually can be performed automatically by a known method. In addition, the processing procedures, the specific names, and the information including various pieces of data and parameters in the above-described document and drawings can be optionally changed unless otherwise specified. For example, various pieces of information in each figure are not limited to the illustrated information.

Furthermore, each component of each illustrated device is functional and conceptual, and does not necessarily need to be physically configured as illustrated. That is, the specific form of distribution/integration of each device is not limited to the illustrated form, and all or part of the device can be configured in a functionally or physically distributed/integrated manner in any unit in accordance with various loads and use situations. For example, the utterance identification unit 112 and the utterance selection unit 113 may be distributed in different devices.

Furthermore, the above-described embodiments and variations can be appropriately combined as long as the processing contents do not contradict each other.

### 7. Conclusion

Although the embodiments of the present disclosure have been described in detail with reference to the accompanying drawings, the present technology is not limited to such examples. It is obvious that a person having ordinary knowledge in the technical field of the present disclosure can conceive various changes or modifications within the scope of the technical idea described in claims, and it is naturally understood that these changes or modifications also belong to the technical scope of the present disclosure.

Furthermore, the effects described in the present specification are merely illustrative or exemplary ones, and are not limitations. That is, the technology according to the present disclosure can exhibit other effects obvious to those skilled in the art from the description of the present specification together with or instead of the above-described effects.

Note that the present technology can also have the configurations as follows.
(1)
An information processing device comprising a control unit that:
performs machine learning using positive example data and negative example data and generates a model;
calculates correspondence rates that a plurality of pieces of example sentence data corresponds to an intention by using the model;
selects presented data to be presented to a user from the plurality of pieces of example sentence data based on a predetermined threshold and the correspondence rates of the plurality of pieces of example sentence data;
receives a determination of whether or not the presented data corresponds to the intention from the user; and
updates the predetermined threshold in accordance with a result of the determination.
(2)
The information processing device according to (1),
wherein the control unit selects another piece of presented data to be presented to the user by using the predetermined threshold that has been updated.
(3)
The information processing device according to (1) or (2),
wherein, when a number of the presented data determined to correspond to the intention by the user coincides with a number of the presented data determined not to correspond to the intention, the control unit ends update of the predetermined threshold.
(4)
The information processing device according to any one of (1) to (3),
wherein, when the user has made the determination a predetermined number of times, the control unit ends the update of the predetermined threshold.
(5)
The information processing device according to any one of (1) to (4),
wherein the control unit performs machine learning again by adding the presented data determined to correspond to the intention by the user in the positive example data and adding the presented data determined not to correspond to the intention by the user in the negative example data, and generates the model.
(6)
The information processing device according to any one of (1) to (5),
wherein, when the presented data is determined to correspond to the intention, the control unit updates the predetermined threshold to a smaller value.
(7)
The information processing device according to any one of (1) to (6),
wherein, when the presented data is determined not to correspond to the intention, the control unit updates the predetermined threshold to a larger value.
(8)
The information processing device according to any one of (1) to (7),
wherein the control unit receives, from the user, a determination of whether or not to exclude the presented data from the plurality of pieces of example sentence data.
(9)
The information processing device according to any one of (1) to (8),
wherein the control unit changes the positive example data having a small correspondence rate to the negative example data in accordance with a determination of the user.
(10)
The information processing device according to any one of (1) to (9),
wherein the control unit changes the negative example data having a large correspondence rate to the positive example data in accordance with a determination of the user.
(11)
An information processing method comprising a processor:
performing machine learning using positive example data and negative example data and generating a model;
calculating correspondence rates that a plurality of pieces of example sentence data corresponds to an intention by using the model;
selecting presented data to be presented to a user from the plurality of pieces of example sentence data based on a predetermined threshold and the correspondence rates of the plurality of pieces of example sentence data;
receiving a determination of whether or not the presented data corresponds to the intention from the user; and
updating the predetermined threshold in accordance with a result of the determination.

### REFERENCE SIGNS LIST

1 INFORMATION PROCESSING SYSTEM
10 INFORMATION PROCESSING DEVICE
20 POSITIVE EXAMPLE/NEGATIVE EXAMPLE DB
30 EXAMPLE SENTENCE DB
110 CONTROL UNIT
111 MODEL GENERATION UNIT
112 UTTERANCE IDENTIFICATION UNIT
1121 FEATURE AMOUNT CALCULATION UNIT
1122 BINARY CLASSIFIER
113 UTTERANCE SELECTION UNIT
1131 SELECTION UNIT
1132 UPDATE UNIT
120 STORAGE UNIT
130 OUTPUT UNIT
140 INPUT UNIT

1. An information processing device comprising a control unit that:
performs machine learning using positive example data and negative example data and generates a model;
calculates correspondence rates that a plurality of pieces of example sentence data corresponds to an intention by using the model;
selects presented data to be presented to a user from the plurality of pieces of example sentence data based on a predetermined threshold and the correspondence rates of the plurality of pieces of example sentence data;
receives a determination of whether or not the presented data corresponds to the intention from the user; and
updates the predetermined threshold in accordance with a result of the determination.

2. The information processing device according to claim 1,
wherein the control unit selects another piece of presented data to be presented to the user by using the predetermined threshold that has been updated.

3. The information processing device according to claim 1,
wherein, when a number of the presented data determined to correspond to the intention by the user coincides with a number of the presented data determined not to correspond to the intention, the control unit ends update of the predetermined threshold.

4. The information processing device according to claim 1,
wherein, when the user has made the determination a predetermined number of times, the control unit ends the update of the predetermined threshold.

5. The information processing device according to claim 1,
wherein the control unit performs machine learning again by adding the presented data determined to correspond to the intention by the user in the positive example data and adding the presented data determined not to correspond to the intention by the user in the negative example data, and generates the model.

6. The information processing device according to claim 1,
wherein, when the presented data is determined to correspond to the intention, the control unit updates the predetermined threshold to a smaller value.

7. The information processing device according to claim 1,
wherein, when the presented data is determined not to correspond to the intention, the control unit updates the predetermined threshold to a larger value.

8. The information processing device according to claim 1,
wherein the control unit receives, from the user, a determination of whether or not to exclude the presented data from the plurality of pieces of example sentence data.

9. The information processing device according to claim 1,
wherein the control unit changes the positive example data having a small correspondence rate to the negative example data in accordance with a determination of the user.

10. The information processing device according to claim 1,
wherein the control unit changes the negative example data having a large correspondence rate to the positive example data in accordance with a determination of the user.

11. An information processing method comprising a processor:
performing machine learning using positive example data and negative example data and generating a model;
calculating correspondence rates that a plurality of pieces of example sentence data corresponds to an intention by using the model;
selecting presented data to be presented to a user from the plurality of pieces of example sentence data based on a predetermined threshold and the correspondence rates of the plurality of pieces of example sentence data;
receiving a determination of whether or not the presented data corresponds to the intention from the user; and
updating the predetermined threshold in accordance with a result of the determination.
